(19) United States
(12) Patent Application Publication
(10) Pub. No.: US 2024/0420445 A1
(43) Pub. Date: Dec. 19, 2024

(54) AIRCRAFT MAINTENANCE SYSTEM AND METHODS

(71) Applicant: Honeywell International Inc., Charlotte, NC (US)

(72) Inventors: Qixiang LI, Tianjin (CN); Le SHI, Beijing (CN)

(21) Appl. No.: 18/334,566

(22) Filed: Jun. 14, 2023

(51) Int. Cl. G06V 10/75; G06T 7/00; G06V 10/82

(52) U.S. Cl. CPC G06V 10/75; G06T 7/0002; G06V 10/82; G06T 2207/20084; G06T 2207/30252

(57) ABSTRACT

Systems and methods for an automated method of detecting and reporting structural defects, comprising: obtaining image data of an aircraft, wherein the image data is captured from one or more fixed locations in an environment surrounding the aircraft; isolating one or more aircraft features from the obtained image data to generate isolated aircraft feature image data that includes isolated aircraft features isolated from one or more aircraft features or non-aircraft features; comparing the isolated aircraft feature image data to stored isolated aircraft feature image data; determining, by a processor configured to execute a deep neural network, one or more anomalies in the isolated aircraft feature image data, wherein the anomaly corresponds to a possible maintenance requirement at a determined location; and comparing the determined location of the possible maintenance requirement to a maintenance standard to generate a maintenance plan including one or more steps for repairing the possible maintenance requirement.

### TECHNICAL FIELD

Various embodiments of the present disclosure relate generally to a detection system and, more particularly, to systems and methods for detecting defects on a surface of an aircraft.

### BACKGROUND

Aircraft require routine inspection to ensure physical integrity of external surfaces and structural components, such as the skin of the fuselage, wings, and other external surfaces such as windows and doors. The size of modern aircraft and frequency at which they must be inspected requires nearly innumerable person-hours of labor. Moreover, human-conducted inspections can be susceptible to errors due to fatigue, inattention, and other human factors or error. The introduction of systems and methods of AI-based or AI-augmented inspections can reduce the number of person-hours required to inspect or monitor aircraft and can eliminate or reduce human factors or errors, making aircraft inspections more likely to identify defects. Thus, AI-based maintenance systems can reduce the cost of maintenance and the cost of fixing structural anomalies identified during an inspection. The features of the present disclosure may solve one or more of the problems set forth above and/or other problems in the art. The scope of the current disclosure, however, is defined by the attached claims, and not by the ability to solve any specific problem.

### SUMMARY OF THE DISCLOSURE

According to certain aspects of the disclosure, systems and methods are disclosed for an automated method of detecting and reporting structural defects, comprising: obtaining image data of an aircraft, wherein the image data is captured from one or more fixed locations in an environment surrounding the aircraft; isolating one or more aircraft features from the obtained image data to generate isolated aircraft feature image data that includes isolated aircraft features isolated from one or more aircraft features or non-aircraft features; comparing the isolated aircraft feature image data to stored isolated aircraft feature image data; determining, by a processor configured to execute a deep neural network, one or more anomalies in the isolated aircraft feature image data, wherein the anomaly corresponds to a possible maintenance requirement at a determined location; and comparing the determined location of the possible maintenance requirement to a maintenance standard to generate a maintenance plan including one or more steps for repairing the possible maintenance requirement.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system environment in which methods, systems, and other aspects of the present disclosure may be implemented;

FIG. 2A depicts an exemplary system for performing inspections of an aircraft using AI-powered systems;

FIG. 2B depicts additional aspects of the exemplary system of FIG. 2A;

FIG. 2C depicts additional aspects in another view of the exemplary system of FIG. 2A;

FIG. 2D depicts additional aspects in another view of the exemplary system of FIG. 2A

FIG. 3A depicts an aircraft surface sectioned into multiple sections;

FIG. 3B depicts additional aspects of the exemplary system of FIG. 2A;

FIG. 4 depicts a data flow diagram for implementing one or more systems or methods of the present disclosure;

FIG. 5A depicts an aircraft segmented into an output image from an input image using one or more of the methods described herein;

FIG. 5B depicts additional aspects of the method depicted in FIG. 5A;

FIG. 5C depicts additional aspects of the method depicted in FIG. 5A;

FIG. 6 is another depiction of an image of an aircraft segmented into multiple segments;

FIG. 7 depicts multiple aircraft with defect detections detected using one or more methods described herein;

FIG. 8 depicts a sample maintenance plan.

FIG. 9 depicts a method of detecting one or more structural anomalies and developing a maintenance plan.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

This invention relates to an aircraft surface defect diagnostic solution. The solution utilizes artificial intelligence (AI) perception technology to discover airframe defects. It is valuable because aircraft operators or maintenance repair overhaul (MRO) suppliers need a low cost, high turn-round aircraft surface structure defect inspection solution. The invention discovers airframe defects from images taken from an aircraft hangar or on an apron. This invention may also include an image capturing device which is a set of cameras mounted on the ceiling of the hangar or light-poles. The output from the AI perception module may flow to a system which refers to the Structural Repair Manual (SRM) and checks the detail of the defect. The invention may then generate one or more repair plans for the defects. The process may consist of an automatic airframe surface section slicing program, comprehensive image capturing, and an image recognition and anomaly detection program(s). As used herein, the term “anomaly” is used to refer to a deviation from a normal or expected state of an aircraft structure or system or related structure or system. The term “defect” is used to refer to an imperfection of an aircraft structure or system or related structure or system. As used herein the term “maintenance” refers to the process of maintaining or preserving an aircraft structure or system or related structure or system.

One or more embodiments reduce the labor and time cost of operators by using AI to inspect the aircrafts' exterior structure overnight. One or more embodiments provide no risk of cameras, personnel, robot arms or drones colliding with an aircraft and cause unexpected damage during the inspection. One or more embodiments may provide architecture that connects all disparate structured (SRM) and unstructured data sources. One or more embodiments may audit trail reporting for structure defects. One or more embodiments may minimize the requirements for image capturing device. One or more embodiments may not require a moving camera or robot arm is not necessary. One or more embodiments may include training data or image data which may be easily collected on the normal aircraft without defects. One or more embodiments may reach good performance with small training dataset, without defect sample. One or more embodiments may reduce man power significantly by only capturing images from fixed locations around the aircraft.

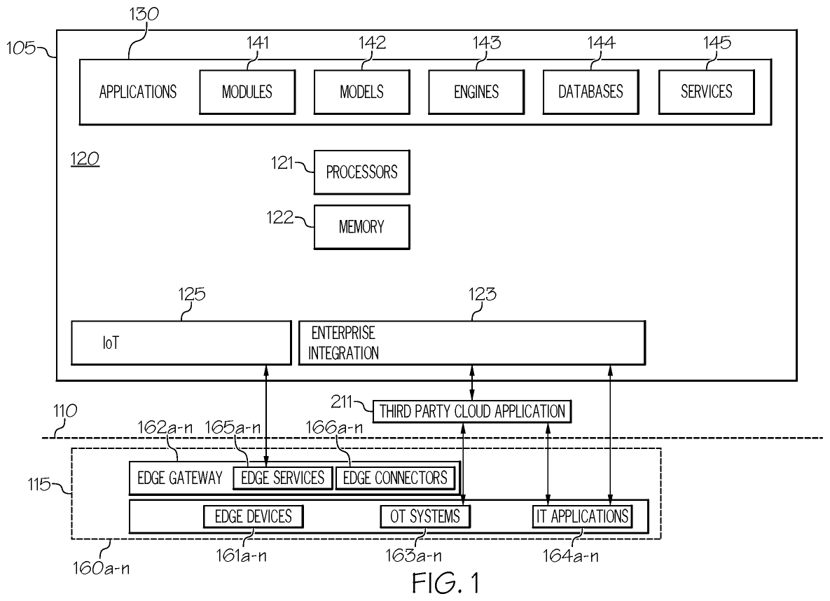

FIG. 1 illustrates an exemplary networked computing system environment 100 for enabling the aircraft maintenance system described herein according to one or more aspects the present disclosure. As shown in FIG. 1, networked computing system environment 100 is organized into a plurality of layers including a cloud 105, a network 110, and an edge 115. As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 including one or more processors 121 and one or more memories 122 that may form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers, which may be integrated by, for example, an enterprise integration 123. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

Computer systems 120 further include one or more applications 130. Applications 130 may be software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, and/or services 145, which may be stored in/by the computer systems 120 (e.g., stored on the memory). According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144 and/or services 145 are combined to form fewer modules, models, engines, databases, services, and/or applications. In some embodiments, some of the modules 141, models 142, engines 143, databases 144 and/or services 145 are separated into separate, more numerous modules, models, engines, databases, services, and/or applications. In some embodiments, some of the modules 141, models 142, engines 143, databases 144 and/or services 145 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, offices, warehouses, laboratories, aircraft, spacecraft, automobiles, ships, boats, military vehicles, oil and gas facilities, or any other type of entity, facility, and/or entity or part thereof that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, vehicle components, cameras, displays, doors, windows, security components, laboratory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. In some cases, any of edge devices 161a-n and edge gateways 162a-n have their functionality combined, omitted, or separated into any combination of devices. In other words, an edge device and its gateway need not necessarily be discrete devices.

The modules 141 may include one or more of, for example, an API module, a reporting services module, a data storage module, an identity management module, a data transformation module, an audit trail/logging module, a domain models module, a permissions module, and/or a data retention module. The various modules may provide data to a connector framework for sending the processed data to one or more databases 144.

The APIs module may provide one or more users (e.g., the systems administrator, the business administrator, etc.) and/or developers with one or more tools (e.g., wizards, UIs, etc.) to design, test, implement, deploy, and manage APIs for use across the environment 100. A user can create one or more intermediaries (e.g., software applications) that may make it possible to read, convert, present, use, manipulate, or otherwise access the data on the systems 120 for presentation or other use in a generated product. The APIs module may be cloud-based and/or locally accessible by one or more users (e.g., the systems administrator, the business administrator, etc.).

The APIs module may be used to allow one or more programs and/or computer systems within the network 110 to communicate with one another. In some embodiments, the APIs module may include an API specification, which may describe how to build and/or use one or more of the APIs built using the API module within the network 110. The APIs module may include one or more subroutines, methods, requests, or endpoints that may be tools used to program the one or more APIs. The APIs module may be used to generate one or more APIs for specific reports.

In some embodiments, the APIs module may be used to build one or more web APIs, which may allow communication between one or more computers or computer systems that may connect the network 110 with another external network (e.g., the Internet). In some embodiments, the web APIs may allow access to one or more computers or computer systems communicatively coupled to the network 110 through one or more client devices (E.g., mobile phones, laptops, etc.). Such devices may connect to the network using, for example, the hypertext transfer protocol (HTTP). These client devices may send a request in the form of an HTTP request. The request may be met with a response message in a different format (e.g., JavaScript Object Notation (JSON), and/or extensible markup language (XML), etc.) In some embodiments, one or more users may use a web API (e.g., a web API created by the APIs module 110) to query the one or more databases 144 for a specific set of data.

The reporting services module may aggregate usage information for various aspects (e.g., files, data, etc.) and may report the usage information to one or more of the various interconnected systems or modules (e.g., the APIs module, the network 110, etc.). For example, if a particular file or data is accessed and/or used, the reporting services module may aggregate data regarding the use of that particular information and report it to one or more internal modules or external systems. The reporting services module may further generate information regarding, for example, statistical information on the amount of usage of components of the system 100.

The data storage module may include one or more storage drives configured to retrieve stored data in response to one or more storage commands received from the system 100 (e.g., from the system admin). The data storage module may include hardware and software components, for example, the data storage module may include a plurality of storage drives (e.g., solid state drives) that may be configured to store and retrieve data in response to storage instructions. Portions of the storage module may be implemented using software modules, such as drivers, services, and/or the like. Other portions of the storage module may be implemented using hardware resources, such as FPGAs, processors, ASICS, hardware controllers, storage controllers, and the like.

The identity management module may provide identity services, such as access management and authorization services, to the network 110. The identify management module may control information about tenants and clients that may utilize the services provided by the system 100. Information used and generated by the identity management module may include authenticating information that identifies users and assigns the users appropriate authorizations for particular system resources. In some embodiments, the identity management module may include a framework of policies and technologies that may safeguard the network 110 such that the correct users (e.g., that are part of the ecosystem connected to the network 110) have the appropriate access to the appropriate resources. The identity management module may enable users to create and/or gain an identity within the ecosystem, assign the created/gained users or other users one or more roles within the ecosystem, and may assign permissions and/or identity grants to the users. The identity management module may store and make available the identities and the technologies supporting that protection (e.g., network protocols, digital certificates, passwords, etc.).

The identity management module may serve various functions throughout multiple stages of a user's interaction with the network 110. For example, during a registration phase, the identity management module may register and authorize access rights. During an operations phase, the identity management module may continuously identify, authenticate, and control the individual identities and/or groups of identities with access to the various hardware and/or software systems of the network 110. The identity management module may serve, for example, five basic functions: pure identity, user access (e.g., log-on), presence-based services, identity federation, and audit function. In some embodiments, the identity management module may be communicatively coupled with one or more external identity management systems that may perform one or more of the functions of the identity management module.

The data transformation module may be configured to transform, convert, and/or translate data acquired from the enterprises 160a-n. The transformation module may be configured to parse data structures acquired from the enterprises a-n and to transform the data into a format that is compatible for use with one or more other components of the system 100 (e.g., one or more other modules or for storage in a database). The system 120 may comprise multiple data transformation modules, where each module may be configured to transform data from one or more of the individual enterprises a-n. The data transformation module may receive a user query and retrieve and transform unstructured or structured data.

The audit trail/logging module may be configured to track, in real time, a request for identity verification and any response from any of the various users of the system 100. In some embodiments, the audit trail/logging module may be configured to track or monitor services performed by various users of the system and by the various components of the system (e.g., one or more servers). The audit trail/logging module may be configured to record a detailed log of actions and events which occur within the system 100. As a result, the system administrator or other user may identify and locate sources of error.

The permissions module may be configured to determine whether a user is authorized to access certain information and/or to perform a particular action within the system 100. The permissions module may query permissions data stored in the system 100. The stored data may indicate required permissions associated with various actions or settings. Users may have varying levels of permission based on different actions/information. The permissions module may access and analyze identity information for particular users to determine an identity of a user. For example, the permissions module may determine permissions of a user based at least in part on the identity of the user.

The data retention module may be configured to detect a data retention triggering event and to initiate one or more data retention. For example, data may be retained in the memory using one or more sets of write parameter values. In some embodiments, the data retention module may be configured to delete all stored data in response to a triggering event. For example, all of a client's stored data may be deleted upon completion and delivery of a report. The data retention module may be configured to initiate an autonomous storage operation or to create sufficient storage space for a particular operation. For example, the data retention module may cause data from the enterprises 160a-n to be stored in a local module within the system 120 for later processing and manipulation (e.g., during report generation).

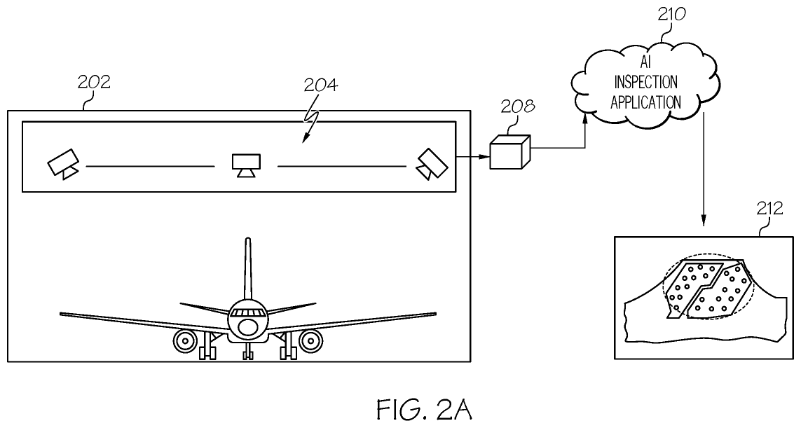

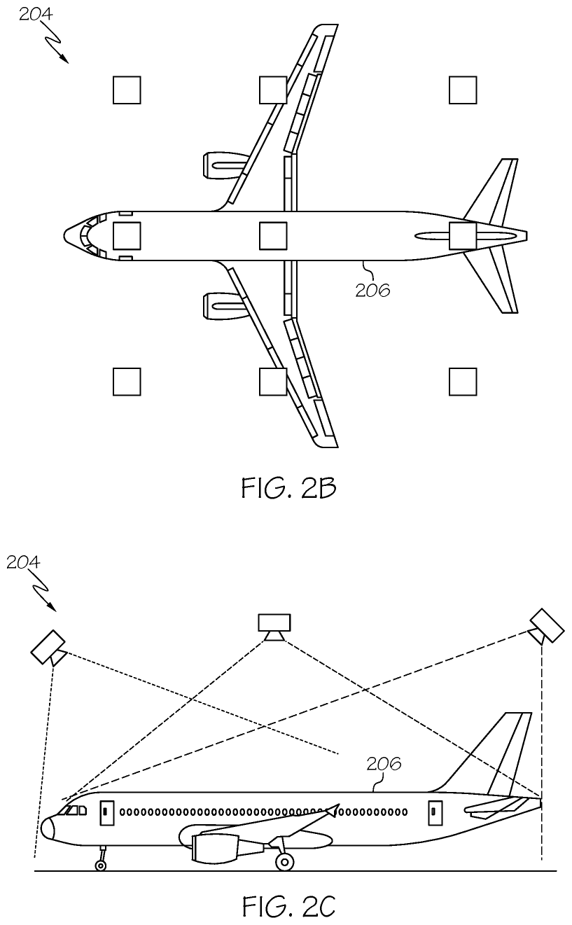

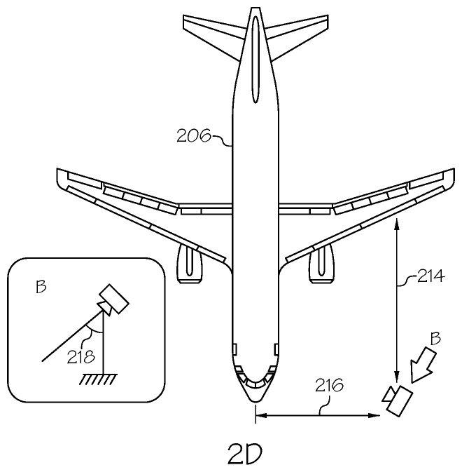

Referring to FIG. 2A, a system 200 for conducting aircraft inspection and maintenance according to one or more aspects of methods described herein is shown. The system 200 can include a hangar 202, a camera system 204 (which may include an array of multiple cameras), an aircraft 206, one or more software modules 208 (e.g., one or more modules described above with respect to FIG. 1), an AI-based inspection application 210 (which may be stored in a cloud network and accessed as described in greater detail herein). The camera system 204 may be used to capture data of one or more structural anomalies 212. The structural anomalies can be cracks, dents, corrosion, scratches, nicks, wear, holes, debonding/delamination, or other damage or combination of such anomalies, which may be caused by, for example, wear during operation, age, exceeding force limitations, strikes by birds or other objects, lightning strikes, etc. _.

FIGS. 2B, 2C, and 2D show further details of the system 200. As shown in FIG. 2B, the camera system 204 can include multiple cameras in an array (e.g., a 3×3 matrix), but this is merely an exemplary arrangement of cameras and they could be arranged with any visual aspect or FOV. The cameras 204 can be both fixed and moveable. In some embodiments, the FOV(s) of the cameras in the camera system 204 may cover an entire body of the aircraft 206 or merely portions thereof. For instance, in some embodiments, the camera system 204 may be configured to capture image data of only one portion of the aircraft 206 and the aircraft 206 or camera system 204 may move to capture images of other portions of the aircraft 206 in turn. The camera system 204 can include any type of image capture device (e.g., optical imagery, thermal imagery, x-ray imagery, etc.)

The cameras can be at any height with respect to the aircraft (i.e., above, below, level with the aircraft). In some embodiments, the cameras may hang from the roof or walls of the hangar, be positioned at various locations within or on the floor, be suspended from light fixtures, etc. In some embodiments, images may be captured using drone-based or robot-based cameras and the location of the drone and/or robot may be determined to fix the location of the camera based thereon with respect to the aircraft 206. The cameras are held in a fixed location with respect to the aircraft 206 and the fixed position may be referenced within the system 200 based on one or more locator dimensions, for example, locator dimension 214 and locator dimension 216. The depicted locator dimensions 214, 216 are exemplary and may be with reference to the position of the aircraft. In some embodiments, an angle, scope, aspect or other dimension 218 of a FOV of the camera may be known and used to calculate a location of the various structural anomalies detected on the aircraft 206 (if any). The aircraft 206 can be positioned within the hangar using one or more markings or other features within the hangar (e.g., markings on a tarmac, etc.) In some embodiments, the aircraft 206 may be configured with one or more autopilot systems to automatically move itself to the appropriate position within the hangar. Various input devices (e.g., personal computers, tablets, etc.) including a display and/or an input device (e.g., touchscreen display, keyboard/mouse/monitor, etc.) may be used to control one or more of the devices, systems, or features described herein (e.g., to change a FOV, location, or other aspect of a camera, etc.)

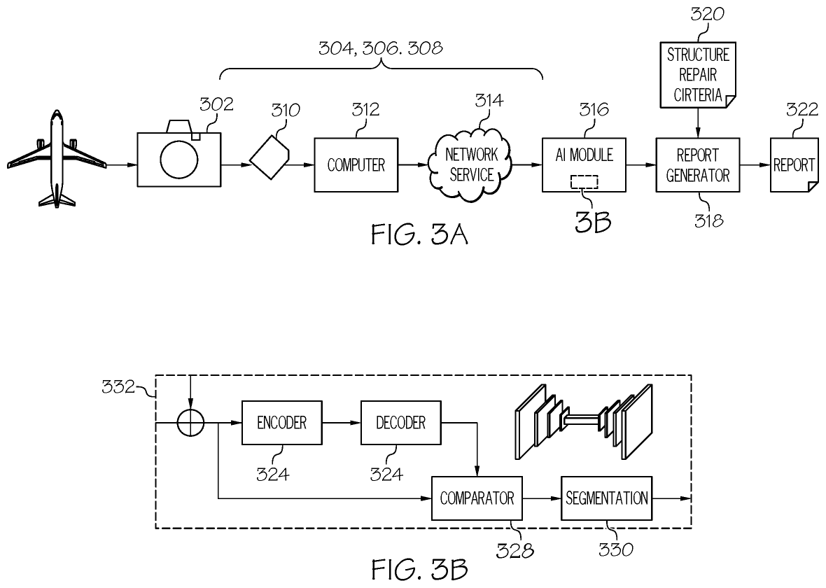

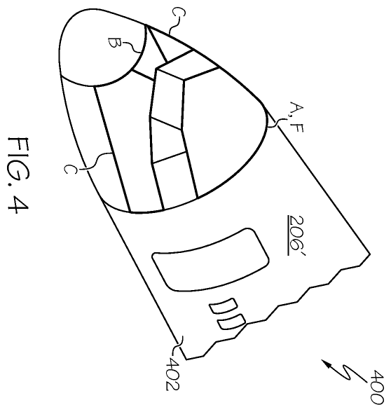

Referring to FIG. 3A and FIG. 3B, a flow diagram for capturing image data, comparing the image data to one or more databases of image data, and generating one or more maintenance reports or maintenance instructions using the system of FIGS. 2A-2D is shown. The flow diagram 300 generally includes image capture 302, image data transmission 304, defect detection 306, and diagnostics 308. The image capture may occur using cameras 204 of FIGS. 2A-2D, for example. The image data captured with the cameras 204 may be uploaded to one or more computing devices 312 using, for example, an SD card 310. In some embodiments, the cameras 204 may be communicatively coupled to a network (e.g., the network 314 (e.g., the Internet) themselves and may not use an SD card to transfer data. The network 314 may provide the image data to an AI module 416 for processing. The AI module 316 may include one or more modules for receiving and processing the image data and generating one or more outputs based on the received and processed data. For example, the AI module 316 may include a defect detection module 332. The defect detection module 332 may include an encoder 324, a decoder 326, a comparator 328, and a segmentation module 330.

The AI module 316 may provide an output to a report generator module 318, which may receive an input from a structure repair criteria 320 to generate a maintenance report 322 based on the output of the AI module 316 and the structure repair criteria 320.

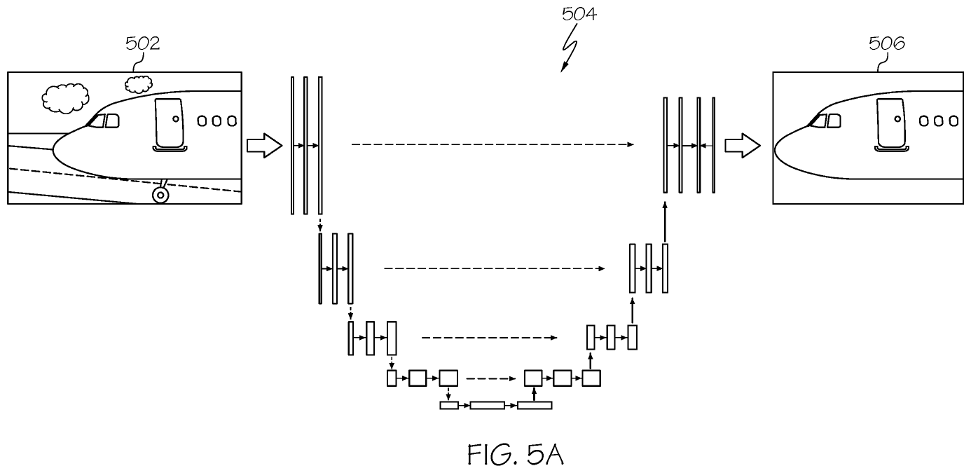

Referring to FIGS. 3A, 3B, and 4, the segmentation module 330 may segment various portions of the aircraft image data into a surface separation scheme 400. The AI module 316 may include the algorithm for separating the features of the surface 402 of the aircraft 206′. The surface separation scheme 400 may correspond with external structures as defined in the airplane zonal coding system (for example, a zonal coding system depicted in FIG. 8). In the particular exemplary embodiment depicted in FIG. 4, the aircraft 206′ is shown broken into different zones: Zone A/F, Zone B, and Zone C. In some embodiments, the zones may use the same letter to refer to mirrored sections of the aircraft 206′ (e.g., across the aircraft centerline on port and starboard sides, respectively). The zones shown in FIG. 4 are exemplary and additional zones, generally covering an entire external surface of the aircraft 206 are considered in embodiments of the system 100.

The AI module 316 may manage the image capture process to capture images from specific areas of the aircraft 206 and to record location information associated with the data captured. Based on the location of the aircraft 206, the known and fixed location of the camera capturing the image, and the image data, the aircraft may determine a zone in which an anomaly is recorded. The location information may refer to the location on the aircraft 206 from which the image data was captured and can include information relating the reference frame from which image data is captured (e.g., a reference position of the camera capturing the image data with respect to the aircraft, a reference angle, an exposure setting, etc.)

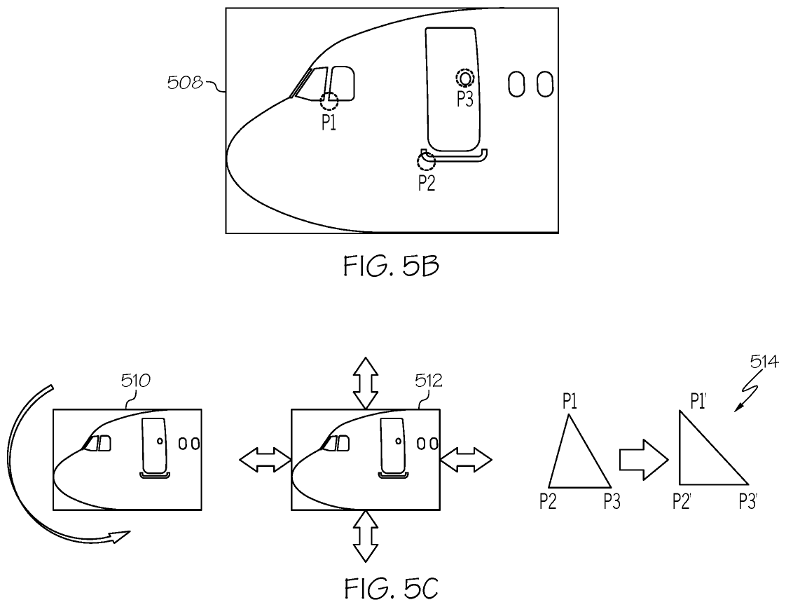

Referring to FIGS. 5A, 5B, and 5C, a process of using a deep neural network to extract the aircraft image from the surrounding image data is shown. FIG. 5A schematically depicts an input image 502, an object segmentation algorithm 504 (e.g., based on one or more deep neural networks (DNN)), and an output image 506. The input image 502 can be raw or processed image data that includes background objects (e.g., clouds, runway, etc.) The object segmentation algorithm 504 may segment the input image 502 to generate the output image 506, which may include only the aircraft and not include the background objects. In embodiments, the DNN may be configured to identify the background objects rather than identifying the aircraft, which could be more computationally and/or resource intensive to identify. Because there may be significant image data readily available for identifying background objects, and such image data may not be readily be available for identifying individual aircraft, the background objects may first be recognized and removed from the image data. For example, there may currently exist many robust models (e.g., recognition models) for recognizing background objects such as trees, building, roads, runways, etc. However, such robust models may not exist for aircraft and aircraft features (e.g., wings, engines, fuselage, landing gear components, etc.) Accordingly, it may be less computationally intensive to first identify background components, subtract these components from digital images, and then identify aircraft structures/components.

The execution of the deep neural network may include a deep learning model, which may include deployment of one or more deep learning techniques, such as linear regression, logistical regression, random forest, gradient boosted machine (GBM), deep learning. The deep neural network may include one or more networks such as a convolutional neural network, a recursive neural network, long-short-term memory deep network, a simple deep learning network, a transformer, etc. Supervised training may be employed. For example, supervised learning may include providing training data and labels corresponding to the training data, e.g., as ground truth (e.g., images of an aircraft and aircraft features taken from a specific angle that are a same class, model, etc. as the target aircraft 206). Any suitable type of training may be used, e.g., stochastic, gradient boosted, random seeded, recursive, epoch or batch-based, etc. In some embodiments, the training data may be trained using image data including false defects to reinforce the determination of actual defects.

Still referring to FIGS. 5A, 5B, and 5C, after the aircraft 206 is effectively identified by segmenting background data from the aircraft the remaining image data is processed using one or more image processing algorithms. For example, the data may be processed using an oriented FAST and rotated BRIEF (ORB) algorithm or using a Template Matching computer vision method to extract at least two feature points from the aircraft image at 508. As shown at FIG. 5B, exemplary feature points include P1, P2, and P3, which correspond to a window corner, a door corner, and a door feature of the aircraft 206. These feature points may be more readily recognizable by algorithms than other points of the aircraft as they present pixels with higher contrast or difference levels from surrounding pixels. Hence, image processing algorithms may more readily recognize these points and use them as anchors to manipulate the surrounding image data. As shown in FIG. 5C, the algorithm may orient the image data a step 510 and at step 512 the image data may be rescaled based on one or more requirements (e.g., zooming for better image of maintenance data, etc.) At step 514, an affine transform may reorient the data, preserving lines and parallelism but not necessarily Euclidean distances and angles. In some embodiments, a pose of the isolated aircraft feature image data may be adjusted to rectify the image of the isolated aircraft feature to match stored image data of one or more other similar aircraft features (e.g., from a trained set of data). The transformations performed at steps 508, 510, 512, and 514 may be based on one or more reference image stored in a database. That is, the image data may be processed to match one or more images or image data stored in the database and used as references for mapping maintenance. The database can be communicatively coupled to the network 314 of FIG. 3A, for example.

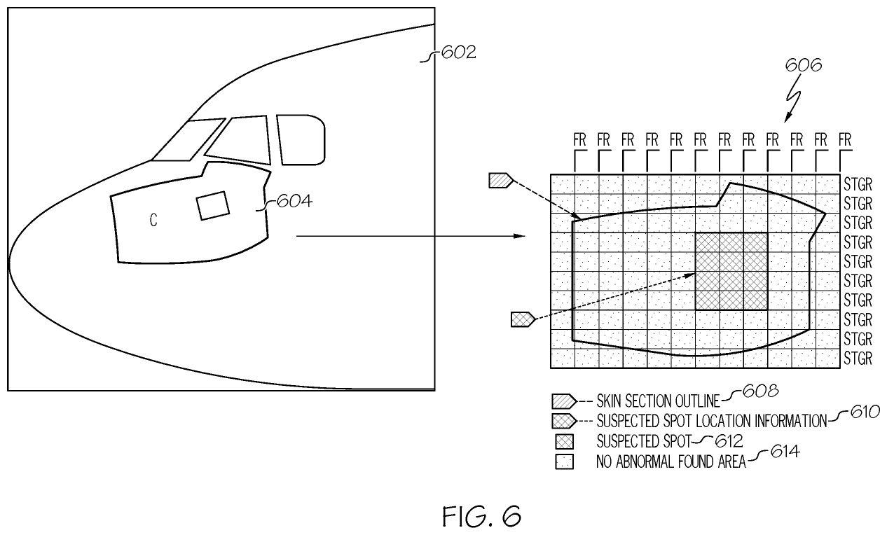

FIG. 6 shows a representative image of an aircraft 602″ including a maintenance grid 604 overlaid on the image of the aircraft 602″. Additional details of the maintenance grid 604 are shown in the zoomed in grid 606. In the grid 606, the surface of the aircraft 602″ is broken into a skin section outline 608, a suspected spot 612 (which may be indicated by the suspected spot location indicator 610), and a normal area 614. The normal area may be that portion of the aircraft surface in which there is not an indication that maintenance needs to be completed (e.g., there are no structural anomalies, structural anomalies are too small to be detected, etc.) The suspected spot 612 is an area that has been determined to require additional maintenance and/or additional inspection (e.g., by human inspectors, more refined artificial intelligence inspection capabilities, etc.) The location of the suspected spot 612 within the grid 606 may be used to develop a maintenance plan.

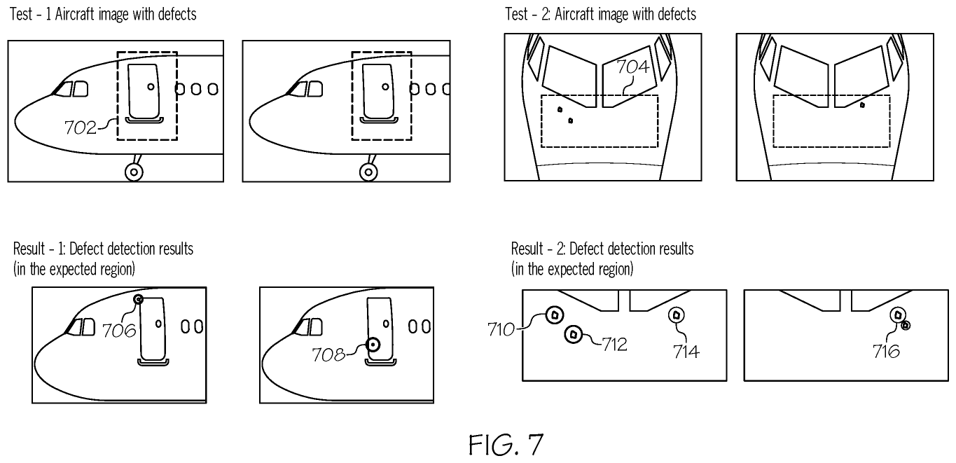

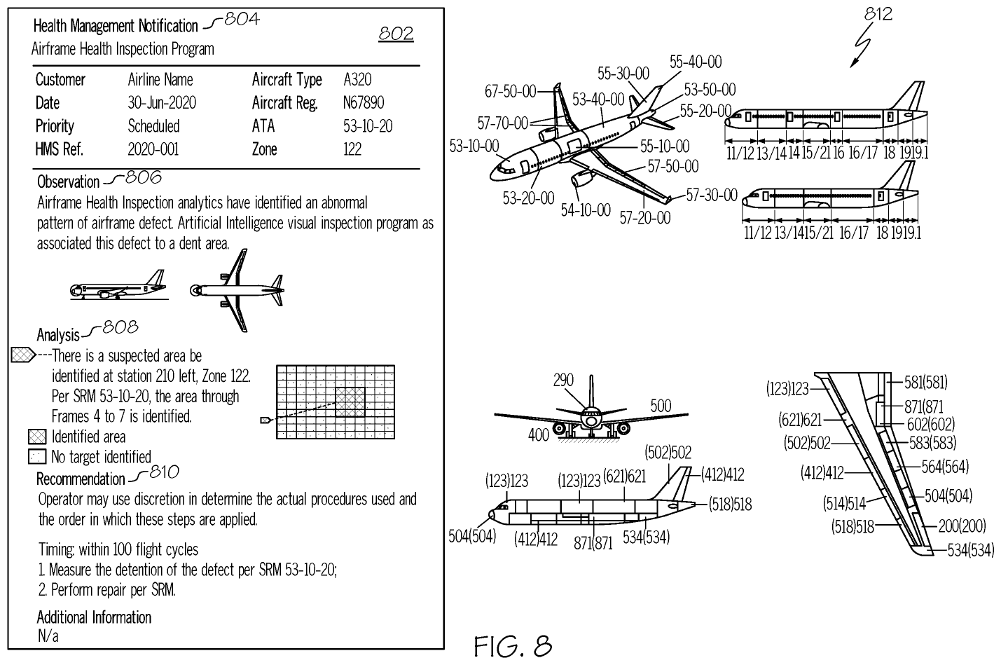

FIG. 7 shows additional examples of locations of suspected structural anomalies. A region 702 surrounding an aircraft door or hatch may be photographed as described herein and one or more features of the aircraft within the photographed region 702 can be used as features to identify the region and map structural anomalies 706, 708 in the identified region 702 to a maintenance plan (e.g., the door or hatch may be used as a feature for determining the image is of a port side, front section of the aircraft). Anomalies 710, 712, 714, and 716 can be mapped similarly using one or more features near the nose of the aircraft to map the anomalies for maintenance or further inspection.

FIG. 8 shows a maintenance plan 802 generated using a maintenance standard and the methods described herein. The maintenance plan 802 may generally include a title 804, an observation 806, an analysis 808, and a recommendation 810. The recommendation 810 may refer to recommended maintenance items for one or more sections on an aircraft 812. The recommended maintenance items can come from one or more standardized maintenance publications (i.e., maintenance standards) that may be stored online or in another database, for example.

The aircraft 812 has its various sections indicated with section indicators in the various views of the aircraft 812 shown in FIG. 8. Each section indicator points to a section that is divisible from the other sections. Databases of image data may be stored of one or more of the sections as training data for executing the one or more deep learning techniques described herein. That is, one or more training data sets may include images of these various aircraft sections and may be labeled appropriately in order to train the deep learning models to identify structural anomalies in aircraft image data captured by the camera system 204 described hereinabove.

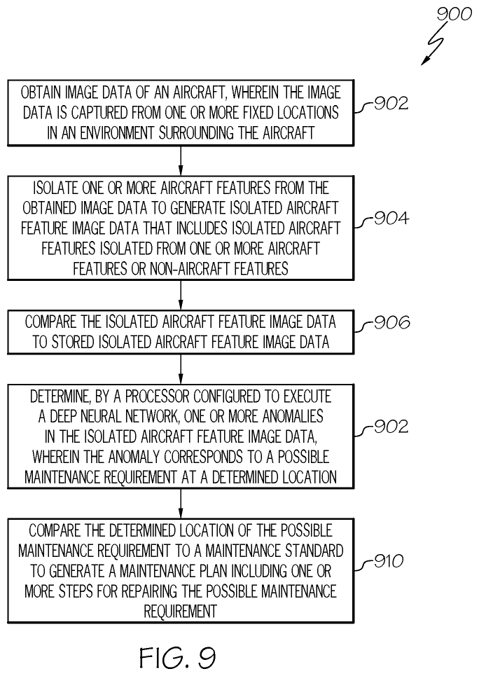

Referring to FIG. 9, a method 900 of generating a maintenance plan for an aircraft is shown. It is to be understood that the method 900 for generating a maintenance plan shown in FIG. 9 is exemplary only and the ordinary artisan in the relevant art will recognize that additional, fewer, or alternate steps may be followed by a user and that any ensuing method would still be in keeping with the scope of the claims below.

At step 902, image data of an aircraft may be obtained. The image data may be obtained using one or more cameras or other visual, thermal, ultraviolet, x-ray or other imagery capturing devices. The image data may be captured from one or more fixed locations in an environment surrounding the aircraft (e.g., the hangar 202). In some embodiments, the cameras or other devices used to capture the image data are configured to capture image data collectively or individually. The capture of image data may be controlled remotely (e.g., through the cloud network) or may be controlled locally using, for example, one or more computing devices. In embodiments, the image data may be captured automatically, for example, upon detection of an aircraft 206 within the hangar 202. The image data may be captured constantly while the aircraft 206 is in the hangar or at discrete times (e.g., on command, on a set schedule, etc.) In embodiments in which thermal or x-ray image data is captured, the temperature within the hangar 206 may be controlled and one or more access controls may be instituted while imagery is captured.

At step 904, one or more aircraft features may be isolated from the obtained image data to generate isolated aircraft feature image data. The isolated aircraft feature image data may include isolated aircraft features isolated from one or more aircraft features or non-aircraft features. The isolated aircraft features may be isolated by recognizing features in the environment and removing the environmental features and non-target aircraft features from the image data. For example, features of the hangar 202 (e.g., the roof, the floor, walls, etc.) may be removed from the image data that is to be used to generate the maintenance plan. Removing such image data makes processing smoother and more efficient because such data does not need to be processed to determine the maintenance plan.

At step 906, isolated aircraft feature image data is compared to stored isolated aircraft feature image data. The stored isolated aircraft feature image data is stored in one or more databases (e.g., in the cloud). The stored isolated aircraft feature data may be trained data with or without anomalies. For example, structural anomalies may be labeled in an image of a nose cone section of an aircraft including one or more anomalies and this image may be stored as training data to identify new anomalies in the same nose cone section of other similar aircraft (i.e., having the same nose cone section).

At step 908, one or more anomalies in the isolated aircraft feature image data may be determined by a processor configured to execute a deep neural network. The anomaly may correspond to a possible maintenance requirement at a determined location. The execution of the deep neural network may include a deep learning model, which may include deployment of one or more deep learning techniques, such as linear regression, logistical regression, random forest, gradient boosted machine (GBM), deep learning. The deep neural network may include one or more networks such as a convolutional neural network, a recursive neural network, long-short-term memory deep network, a simple deep learning network, a transformer, etc. Supervised training may be employed. For example, supervised learning may include providing training data and labels corresponding to the training data, e.g., as ground truth (e.g., images of an aircraft and aircraft features taken from a specific angle that are a same class, model, etc. as the target aircraft 206). Any suitable type of training may be used, e.g., stochastic, gradient boosted, random seeded, recursive, epoch or batch-based, etc.

At step 910, the determined location of the possible maintenance requirement may be compared to a maintenance standard to generate a maintenance plan including one or more steps for repairing the possible maintenance requirement. The maintenance plan can include, for example, an observation (e.g., abnormal pattern of aircraft defect, etc.), an analysis (e.g., a location of the anomaly as compared to an aircraft maintenance map, etc.), and a recommendation (e.g., perform more in depth analysis, physically inspect, etc.) In some embodiments, the maintenance plan can include a priority of the maintenance item (e.g., strictly necessary, recommended, etc.) The maintenance plan can include one or more steps for completing the maintenance and/or may refer a user to one or more maintenance cards or maintenance reference manuals for completing the maintenance item. In some embodiments, the maintenance plan may provide one or more links to maintenance items that are stored in a database or other external storage (e.g., in the cloud, the Internet, etc.) and the links may take the user to a maintenance plan stored in the external storage. In some instances, the maintenance plan can include a prioritization, which may give a user an indication of a criticality of the maintenance item, for example, an aircraft may be grounded until some maintenance is completed but may continue for a number of cycles after a maintenance anomaly is identified in less critical instances

Other embodiments of the disclosure will be apparent to those skilled in the art from consideration of the specification and practice of the embodiments disclosed herein. It is intended that the specification and examples be considered as exemplary only, with a true scope and spirit of the present disclosure being indicated by the following claims.

What is claimed is:

1. An automated method of detecting and reporting structural defects, comprising:
obtaining image data of an aircraft, wherein the image data is captured from one or more fixed locations in an environment surrounding the aircraft;
isolating one or more aircraft features from the obtained image data to generate isolated aircraft feature image data that includes isolated aircraft features isolated from one or more aircraft features or non-aircraft features;
comparing the isolated aircraft feature image data to stored isolated aircraft feature image data;
determining, by a processor configured to execute a deep neural network, one or more anomalies in the isolated aircraft feature image data, wherein the anomaly corresponds to a possible maintenance requirement at a determined location; and
comparing the determined location of the possible maintenance requirement to a maintenance standard to generate a maintenance plan including one or more steps for repairing the possible maintenance requirement.

2. The method of claim 1, wherein a pose of the isolated aircraft feature image data is adjusted to rectify the image of the isolated aircraft feature to match stored image data of one or more other similar aircraft features.

3. The method of claim 2, wherein the pose of the isolated aircraft feature image data is adjusted such that the image of the isolated aircraft feature is comparable to a maintenance plan image of a similar aircraft feature.

4. The method of claim 1, wherein the image data further includes image data captured from one or more moveable cameras.

5. The method of claim 4, wherein the one or more moveable cameras are mounted on one or more drones or robotic arms.

6. The method of claim 1, wherein the one or more aircraft features are isolated from the obtained image data using a deep neural network trained to identify non-aircraft objects in the obtained image data.

7. The method of claim 1, wherein the fixed locations are known with respect to a location of the aircraft based on one or more reference dimensions.

8. The method of claim 7, wherein the reference dimensions are referenced with respect to an immobile object and the aircraft is configured to park at a reference point with respect to the immobile object while image data is obtained.

9. The method of claim 1, wherein the maintenance plan identifies the determined location with respect to one or more maintenance zones of the aircraft.

10. The method of claim 9, wherein the deep neural network trained to determine one or more anomalies in the isolated aircraft feature image data is trained using image data including false defects to reinforce the determination of actual defects.

11. An automated method of detecting and reporting structural defects, comprising:
obtaining image data of an aircraft including one or more of visual, thermal, or x-ray image data, wherein the image data is captured from one or more locations in an environment surrounding the aircraft;
isolating one or more aircraft features from the obtained image data to generate isolated aircraft feature image data that includes isolated aircraft features isolated from one or more non-aircraft features;
comparing the isolated aircraft feature image data to a training set of data including stored isolated aircraft feature image data based on an aircraft model;
determining, by a processor configured to execute a deep neural network, one or more anomalies in the isolated aircraft feature image data, wherein the anomaly corresponds to a possible maintenance requirement at a determined location; and
comparing the determined location of the possible maintenance requirement to a maintenance standard to generate a maintenance plan including one or more steps for repairing the possible maintenance requirement.

12. The method of claim 11, wherein a pose of the isolated aircraft feature image data is adjusted to rectify the image of the isolated aircraft feature to match stored image data of one or more other similar aircraft features.

13. The method of claim 12, wherein the pose of the isolated aircraft feature image data is adjusted such that the image of the isolated aircraft feature is comparable to a maintenance plan image of a similar aircraft feature.

14. The method of claim 11, wherein the image data further includes image data captured from one or more moveable cameras.

15. The method of claim 14, wherein the one or more moveable cameras are mounted on one or more drones or robotic arms.

16. The method of claim 11, wherein the one or more aircraft features are isolated from the obtained image data using a deep neural network trained to identify non-aircraft objects in the obtained image data.

17. A system for generating one or more maintenance plans comprising:
one or more cameras at fixed locations in an environment surrounding an aircraft;
a processing device; and
a memory communicatively coupled to the processing device and storing one or more instructions that when executed by the processing device cause the system to:
obtain image data of an aircraft, wherein the image data is captured from one or more fixed locations in an environment surrounding the aircraft;
isolate one or more aircraft features from the obtained image data to generate isolated aircraft feature image data that includes isolated aircraft features isolated from one or more aircraft features or non-aircraft features;
compare the isolated aircraft feature image data to stored isolated aircraft feature image data;
determine, by a processor configured to execute a deep neural network, one or more anomalies in the isolated aircraft feature image data, wherein the anomaly corresponds to a possible maintenance requirement at a determined location; and
compare the determined location of the possible maintenance requirement to a maintenance standard to generate a maintenance plan including one or more steps for repairing the possible maintenance requirement.

18. The system of claim 17, wherein the cameras include one or more visual, thermal, and x-ray cameras.

19. The system of claim 17, wherein the cameras are fixed above and below the aircraft.

20. The system of claim 17, wherein the aircraft is positioned in a hangar.
